(19) United States
(12) Patent Application Publication
(10) Pub. No.: US 2008/0024796 A1
(43) Pub. Date: Jan. 31, 2008

(54) APPARATUS AND METHOD FOR SENSING THE POSITION OF A SUSCEPTOR IN SEMICONDUCTOR DEVICE MANUFACTURING EQUIPMENT

(75) Inventor: Jeong-Cheol SHIN, Osan-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., SUWON-SI (KR)

(21) Appl. No.: 11/747,301

(22) Filed: May 11, 2007

(30) Foreign Application Priority Data
Jul. 31, 2006 (KR) 2006-0071893

(51) Int. Cl. G01B 11/14

(52) U.S. Cl. 356/615

(57) ABSTRACT

An apparatus for sensing the position of a susceptor in a semiconductor device manufacturing equipment comprises a susceptor which receives a wafer and high frequency power, a sensor unit which irradiates light to a lower face of the susceptor when the susceptor is in a lifted up state and which receives light reflected from the lower face of the susceptor, a light path measuring unit which measures a length of the light reflected to the sensor unit, an operating unit which compares the length of the light measured by the light path measuring unit with reference data indicating a rising height of the susceptor, and which decides whether the length of the measured light is within a range of the reference data, and a controller which interlocks a process equipment when the length of the measured light deviates from the range of the reference data, and which controls a horizontal level state of the susceptor.

### BACKGROUND AND SUMMARY

1. Field of the Invention

The present invention relates to semiconductor device manufacturing equipment and, more particularly, to a susceptor positional sensing apparatus for use in semiconductor device manufacturing equipment, and a method of sensing a position of a susceptor.

A claim of priority under 35 U.S.C. §119 is made to Korean Patent Application 10-2006-0071893, filed on Jul. 31, 2006, the contents of which are hereby incorporated by reference in their entirety for all purposes as if fully set forth herein.

2. Description of the Related Art

The manufacturing cycle of a semiconductor device includes a number of unit processes. These unit processes include, for example, an impurity ion implantation process, a thin film deposition process, an etching process, a CMP(Chemical Mechanical Polishing) process, and a cleaning process. Typically, the impurity ion implantation process involves implanting impurity ions of group 3B, e.g., B, or group 5B, e.g., P or As, into the interior of a semiconductor substrate. The thin film deposition process generally involves forming an insulation or conductive film on a semiconductor substrate. The etching process includes forming the film deposited through the thin film deposition process into a given pattern. The CMP process involves depositing an interlayer insulation layer on a semiconductor substrate and polishing the deposited layer to remove any step formations on the surface of the semiconductor substrate. The cleaning process includes removing pollution materials from the wafer and a process chamber used for the semiconductor fabrication process.

In particular, a number of the unit processes described above are performed in the process chamber of semiconductor manufacturing equipment. Furthermore, the unit processes are generally performed in a state where a wafer is loaded on a susceptor used to support the wafer. In particular, the susceptor may include a wafer support portion that includes a chuck and a cathode. The interior space of the process chamber performing unit processes requires process parameters adequate to a process characteristic.

The internal space of a process chamber where all unit processes are carried out should typically be configured such that the various unit processes are performed satisfactorily. For example, the process chamber includes a space between an upper electrode and a lower electrode (cathode). This space is the region where plasma is formed. Furthermore, the space, (i.e., the distance) between the upper and lower electrodes in the process chamber, may be important for a satisfactory plasma etching process. Specifically, the distance between the upper electrode and the cathode is measured during a preventive maintenance (PM) procedure of the process chamber. This measured distance is then adjusted such that it is within a range that is adequate for the plasma dry etching process.

In general, a gap between the upper electrode and the cathode is controlled by an up and down movement of the cathode. In other words, the cathode is driven upwards and downwards by a gap assembly that may include a gap motor, a gap shaft and a gap chain etc.

Generally, to smoothly perform a plasma etching process on a film deposited on a wafer, a gap between an upper electrode and a cathode should be maintained at a constant level. However, there may be a case where the cathode is slanted and/or a level of the cathode is unbalanced due to problems with the semiconductor manufacturing equipment. For example, a fixation screw of ball screw may loosen which may lead to a shaft being twisted, or a gear being abraded. In addition, or alternatively, a chain may loosen up and may unbalance the cathode.

The slanting or unbalancing of the cathode in the process chamber may lead to various problems. For example, in case the cathode is slanted, an inner wall of the process chamber is scratched. This scratching may cause the dropping of polymer that was generated in the etching process and was fixed to the inner wall, thus polluting a wafer. Furthermore, if the cathode is slanted, a horizontal level of wafer loaded on the cathode also becomes unbalanced. This unbalancing may lead to etching rates for respective positions of wafers to differ substantially, lowering the reliability and the production yield of semiconductor device manufacturing equipment.

Conventionally, a horizontal level of the cathode is checked by verifying a tension of a chain and the gear state while performing the PM. That is, three jigs having a convex shape are disposed with the same interval on the cathode. When the cathode goes up and down, then amount of movement of the jigs is measured by opening the process chamber. At this time, when the difference in movement between the jigs is more than 0.1 mm, a determination may be made that the horizontal level of the cathode is unbalanced.

While the conventional method of ensuring the proper level and balance of the cathode is useful, it suffers from various limitations. For example, the conventional method is performed only during the PM because the process chamber has to be opened to verify the movement of the jigs. Furthermore, because the balance of the cathode can be only checked during the PM, there is a problem in that the level of the cathode cannot be monitored in real time. Therefore, immediate damage to the equipment and wafers caused due to the unbalancing of the cathode cannot be prevented.

The present disclosure is directed towards overcoming one or more shortcomings of the conventional semiconductor manufacturing equipment and method.

### SUMMARY OF THE INVENTION

One aspect of the present disclosure includes an apparatus for sensing the position of a susceptor in semiconductor device manufacturing equipment. The apparatus comprises a susceptor which receives a wafer and high frequency power, a sensor unit which irradiates light to a lower face of the susceptor when the susceptor is in a lifted up state and which receives light reflected from the lower face of the susceptor, a light path measuring unit which measures a length of the light reflected to the sensor unit, an operating unit which compares the length of the light measured by the light path measuring unit with reference data indicating a rising height of the susceptor, and which decides whether the length of the measured light is within a range of the reference data, and a controller which interlocks a process equipment when the length of the measured light deviates from the range of the reference data, and which controls a horizontal level state of the susceptor.

Another aspect of the present disclosure includes an apparatus for sensing the position of a susceptor in semiconductor device manufacturing equipment. The apparatus comprises a susceptor which receives a wafer and high frequency power, a bellows formed under the susceptor, which supports the susceptor, a flange formed under the bellows, the flange having a plurality of ball screws piercing there through, and ascending and descending in a vertical straight movement of the ball screws, the ball screws having the vertical straight movement according to a drive of motor, a ball screw fixation plate formed in an upper end portion of the ball screw driving the flange in a vertical direction, the ball screw fixation plate being configured to fix the ball screw, a sensor unit formed on the ball screw fixation plate, which irradiates light to a lower face of the susceptor when the susceptor is in a lifted up state, and which receives light reflected from the lower face of the susceptor, a light path measuring unit which measures a length of the light reflected to the sensor unit, an operating unit which compares the length of the light measured by the light path measuring unit, with reference data indicating a rising height of the susceptor, and which decides whether the length of the measured light is within a range of the reference data, and a controller which interlocks a process equipment when the length of the measured light deviates from the range of the reference data, and which controls a horizontal level state of the susceptor.

Yet another aspect of the present disclosure includes a method of sensing the position of a susceptor in semiconductor device manufacturing equipment. The method comprises supplying a wafer into a process chamber, lifting up a susceptor on which the wafer supplied into the process chamber will be mounted, irradiating light to a lower face of the lifted-up susceptor, receiving light reflected from the lower face of the susceptor, and measuring a length of the reflected light, determining whether the length of the reflected light is within a range of reference data indicating a rising height of the susceptor, and interlocking a process equipment when the length of the reflected light deviates from the range of the reference data, and controlling a horizontal level state of the susceptor.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 illustrates a semiconductor device manufacturing equipment employing a cathode level sensing apparatus according to an exemplary disclosed embodiment;

FIGS. 2A and 2B illustrate a procedure for moving a cathode up/down using a gap assembly according to an exemplary disclosed embodiment;

FIG. 3 illustrates a plane structure of a ball screw fixation plate in which a sensor unit of a cathode level sensing apparatus is formed according to an exemplary disclosed embodiment;

FIG. 4 is a block diagram of a cathode level sensing apparatus according to an exemplary disclosed embodiment; and

FIG. 5 is a flowchart illustrating a procedure of sensing a horizontal level of cathode in a cathode level sensing apparatus according to an exemplary disclosed embodiment.

### DETAILED DESCRIPTION

Embodiments of the present invention now will be described more fully hereinafter with reference to the accompanied drawings, in which embodiments of the invention are shown. This invention may, however, be embodied in many different forms and should not be construed as limited to the embodiments set forth herein. Rather these embodiments are provided so that this disclosure will be thorough and complete, and will fully convey the scope of the invention to those skilled in the art.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. Exemplary embodiments of the present invention are more fully described below with reference to the accompanied drawings. This invention may, however, be embodied in many different forms and should not be construed as being limited to the exemplary embodiments set forth herein; rather, these exemplary embodiments are provided so that this disclosure is thorough and complete, and conveys the concept of the invention to those skilled in the art.

As semiconductor devices are increasingly becoming highly integrated, the unit processes used to fabricate such devices have to be increasingly precise. Some of these unit processes include, for example, a material film deposition to form a material film on a wafer, a dry etching (anisotropic etching) to form the material film deposited on the wafer into a given pattern to perform a specific function, an ashing process to eliminate a photosensitive film covering an upper part of the wafer in order to proceed with an etching process or to eliminate a photosensitive film hardened by a reaction to an etching gas, etc.

However, it may be important to precisely control various process parameters of a process chamber in which the unit processes are performed, before trying to enhance a precision of the unit processes by using materials such as plasma. In particular, a gap between an upper electrode and a cathode, in which plasma is formed, is one of the major parameters that may have an influence upon a success/failure of a plasma etching process. Specifically, the upper electrode may be configured to fix to an upper region of the process chamber, while the cathode ascends and descends during the loading and unloading of a wafer so as to keep the gap constant. Thus the gap between the upper electrode and the cathode is formed, depending upon an up and down motion of the cathode.

The vertical movement of the cathode may lead to problems. For example, the cathode ascends and descends whenever the wafer is loaded and unloaded. This movement of the cathode may cause a fixation screw of a ball screw moving up and down to loosen. This loosening of the fixation screw may twist a shaft balance or abrade a gear, or loosen a chain. All of these effects may unbalance the cathode. However, in the conventional art, the level of the cathode could be checked only in the PM. Thus, the level of the cathode could not be checked real-time. This inability to check for the level of the cathode real-time may lead to the wastage of wafers because some wafers may be malformed due to the improper positioning of the cathode. This wastage of wafers may lead to a lower reliability and lower production yield of semiconductor devices.

Generally, exemplary disclosed embodiments include an apparatus and method of sensing a horizontal level of cathode through real time monitoring. Specifically, a horizontal level state of the cathode in a process chamber can be monitored in real time whenever a wafer is loaded. Therefore, a distance between an upper electrode and a cathode within a process chamber can be kept constant, thereby performing a smooth plasma etching process and substantially enhancing a reliability and production yield of semiconductor devices. To this end, an apparatus and method of sensing a horizontal level of a lower electrode according to some embodiments of the invention will be described referring to the accompanied drawings, as follows.

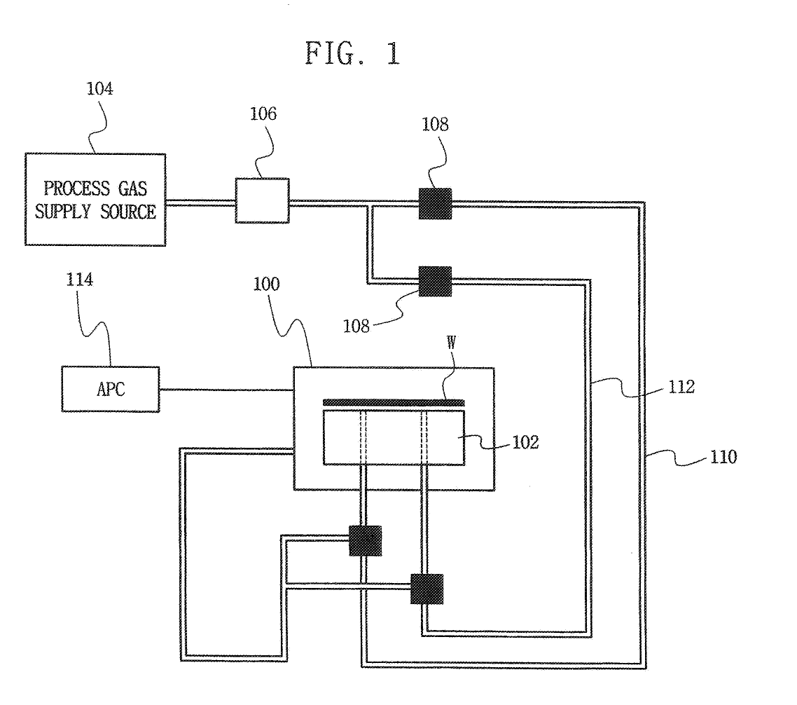

FIG. 1 illustrates semiconductor device manufacturing equipment employing a horizontal level sensing apparatus according to an exemplary disclosed embodiment. Referring to FIG. 1, the equipment includes a process chamber 100 having a susceptor 102 on which a wafer(w) is mounted, a process gas supply source 104 which supplies a plasma forming gas, such as helium(He) etc. into the process chamber 100, a manometer 106 which controls pressure of process gas such as helium etc. supplied from the process gas supply source 104, an MFC (Mass Flow Controller) 108 for controlling a mass flow of the process gas supplied from the process gas supply source 104, a first gas supply line 1 10 and a second gas supply line 112 which supply the process gas into the process chamber 100.

The process chamber 100 is a space which may be used for an etching process using plasma. In performing a plasma etching process, a wafer (w) is loaded on the susceptor 102, and process gas for an etching process is injected into the process chamber 100. Then, RF power is applied to an upper electrode(not shown) formed in an upper region of the process chamber 100, and a cathode(not shown) formed within the susceptor 102, thus changing the process gas injected into the process chamber 100, into a plasma state. Thereby a material layer deposited on the wafer W is etched into a desired pattern by using the plasma.

In an exemplary embodiment, a horizontal level sensing apparatus is installed in the cathode formed within the susceptor 102. When the cathode ascends to load the wafer provided through a slit door (not shown) of a sidewall of the process chamber 100, a horizontal level state of the ascending cathode is monitored through the horizontal level sensing apparatus. During the monitoring process, if it is determined that the horizontal level state of the cathode is unbalanced, the equipment is interlocked and a horizontal level state of the cathode is adjusted to be included within a reference range. Then, the cathode descends to complete the etching process. Such monitoring for the horizontal level state of the cathode may be done whenever a wafer is supplied into a process chamber through slit door. This monitoring of the horizontal level of a wafer may prevent the unbalancing of the cathode.

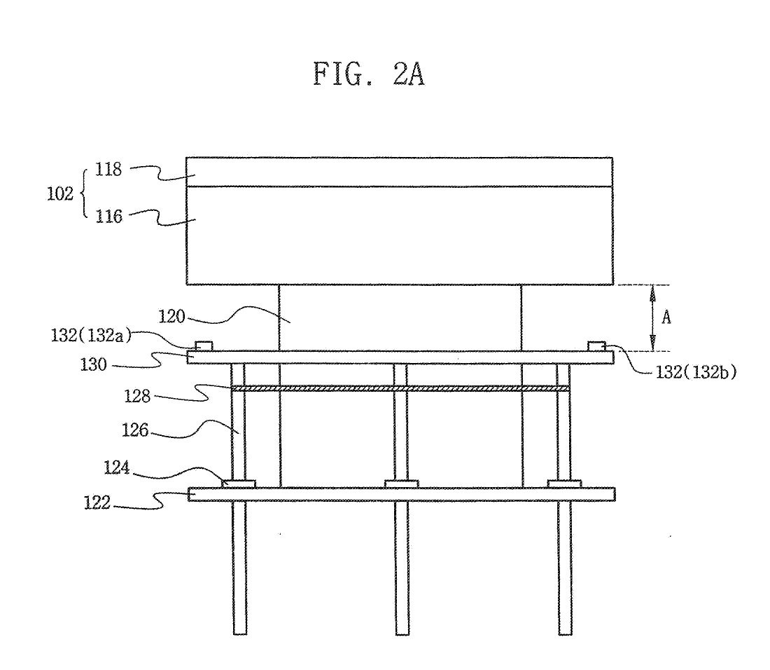

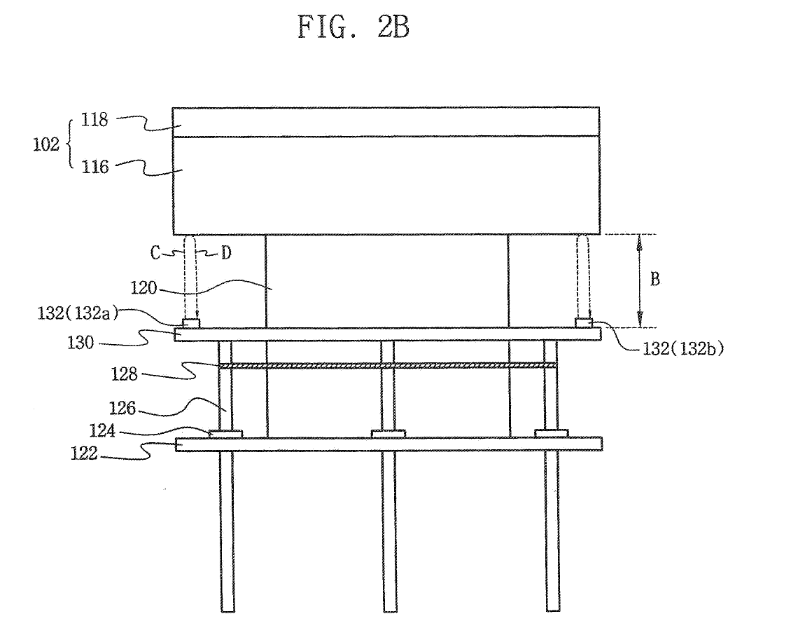

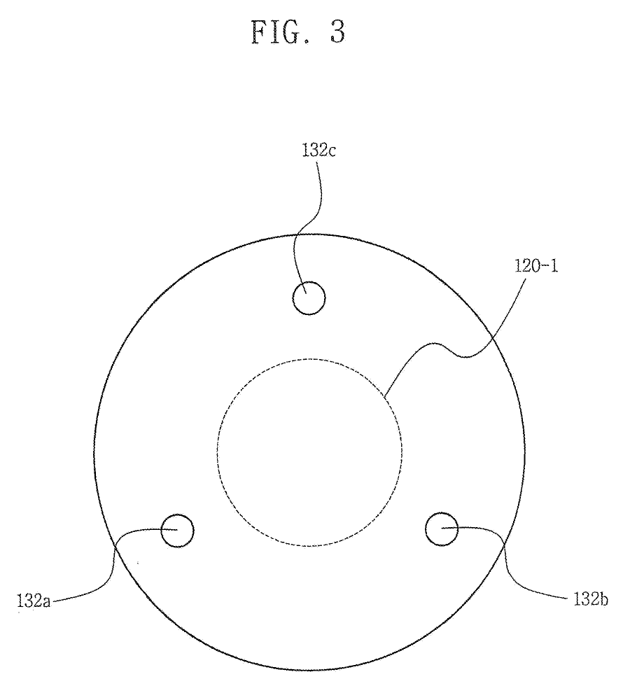

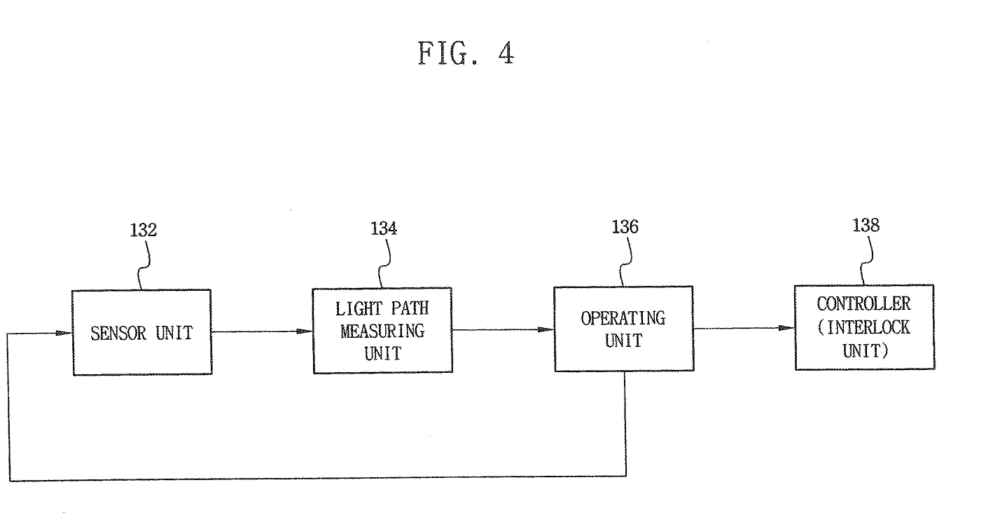

FIGS. 2A and 2B illustrate procedures used by the susceptor 102 of FIG. 1 to ascend and descend using a gap assembly according to an exemplary disclosed embodiment. FIG. 3 illustrates a plane structure of a ball screw fixation plate in which a sensor unit of the exemplary disclosed cathode level sensing apparatus is formed. FIG. 4 is a block diagram of a cathode level sensing apparatus according to an exemplary disclosed embodiment

Referring first to FIG. 2A, the susceptor 102 in which a wafer is mounted, includes a cathode 116 and an electrostatic chuck 118. Furthermore, a high frequency power is provided to the cathode 116 for the formation of plasma. A gap bellows 120 supporting the cathode 116 is formed under the cathode 116. Moreover, a flange 122 having four via-holes is formed under the gap bellows 120. The flange 122 moves up or down according to driving of ball screw 126. Furthermore, a ball ledge 124 surrounding the via-hole of the flange 122 is formed in the neighborhood of the via-hole of the flange 122. Also, a ball screw 126 pierces through the ball ledge 124 that has an up and down movement according to a drive of motor(not shown). Specifically, a total of four ball screws 126 are provided in an exemplary disclosed embodiment. Furthermore a gap chain 128 is provided to fix the four ball screws 126 when they move upwards and downwards. Although only three ball screws 126 are shown in FIG. 2A, actually a total of four ball screws are provided herein.

A ball screw fixation plate 130 is formed on the upper ends of the ball screws 126 to drive the flange 122 upwards and downwards. The plate 130 is also used to fix the ball screws 126. The ball screw fixation plate 130 may include several components. For example, sensor units 132 are formed on the ball screw fixation plate 130 to monitor a horizontal level state of the cathode 116. Each of the sensor units 132 may be formed of a photosensor, and may be constructed of a first sensor 132a, a second sensor 132b, and a third sensor 132c, all of which are disposed with the same interval on the ball screw fixation plate 130, as shown in FIG. 3. In an exemplary embodiment, the number of sensors constituting the sensor unit 132 may depend on the type of equipment. As shown in FIG. 4, the sensor unit 132, a light path measuring unit 134, an operating unit 136 and a controller (an interlock unit) 138 constitute a cathode level sensing apparatus according to an exemplary disclosed embodiment. The ball screw fixiation plate 130 may have a structure (for example, a hole 120-1 shown in FIG. 3) through which the gap bellows 120 may passes.

As shown in FIGS. 2A and 2B, when a gap motor (not shown) is driven, four ball screws 126 perform a vertical up/down movement through the ball ledges 124. This movement of the ball screws 126 drives the flange 122 upwards and downwards. In addition, the up and down drive of the flange 122 shrinks the bellows 120 so that the cathode 1 16 ascends and descends.

In the disclosed gap assembly structure, the ball screw 126 may receive a number of loads of the equipment causing the ball screw 126 to perform an up and down straight movement. This successive up and down movement of the ball screw 126 applies a load to the ball ledge 124 causing a twist effect. If the ball ledge 124 is twisted, a horizontal level state of the cathode 116 is unbalanced. This unbalanced level of the cathode 116 may cause the cathode 116 to scratch the walls of the process chamber 102 (see FIG. 1) and thus damage the process chamber 102. Furthermore the gap between the upper electrode and the cathode may deviate from the allowable limit. This unwanted change in the gap between the upper electrode and the cathode may prevent a smooth plasma etching process from being performed.

Therefore, in an exemplary disclosed embodiment, the horizontal level state of cathode is monitored in real time by using a cathode level sensing apparatus shown in FIG. 4, thereby controlling an interval between an upper electrode and a cathode such that the interval lies within an acceptable range. With reference to FIGS. 2A, 2B and 4, light is irradiated on to a lower face of the cathode 116 by using a light emitting sensor constituting the sensor unit 132. The irradiated light C is reflected from the lower face of the cathode 116 and the reflected light D is incident on the light path measuring unit 134. The light path measuring unit 134 measures a length of the reflected light D, then transmits this length data to the operating unit 136. The operating unit 136 compares the length data of the reflected light D with a predetermined reference data such as, for example, data indicating a rising height of the cathode. When the length data of the reflected light has deviated from a range of the reference data, the controller 138 automatically stops an operation of the plasma etching equipment.

As described above, a horizontal level state of the cathode is monitored in real time by using the cathode level sensing apparatus like in FIG. 4, and in case the horizontal level state of the cathode is unbalanced, the equipment automatically stops, thereby preventing a loss of the equipment and wafers and providing a smooth plasma etching process.

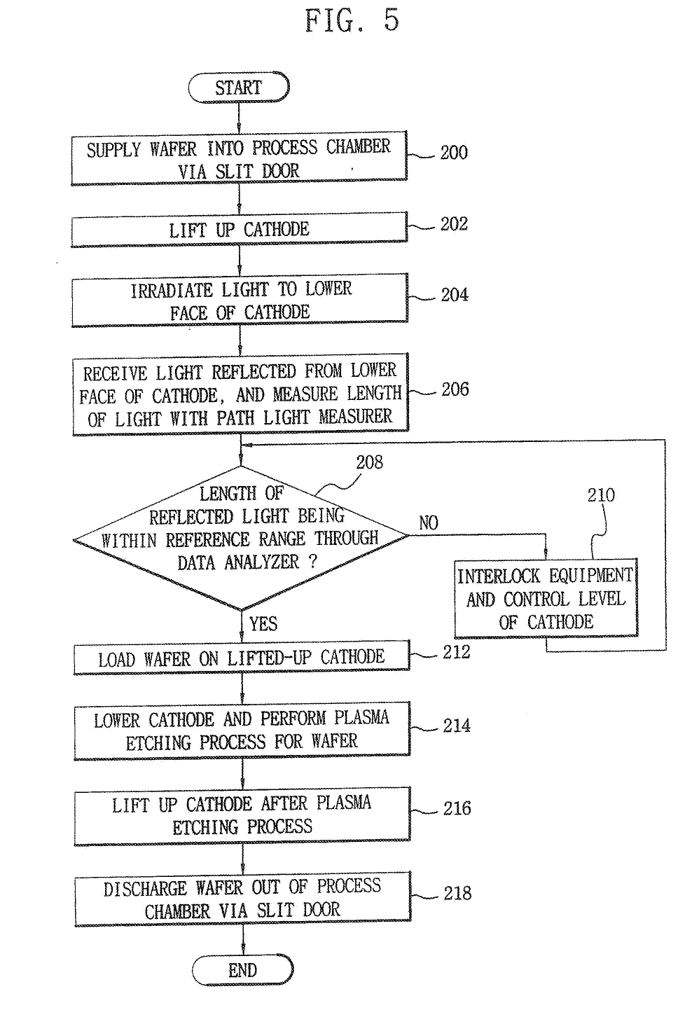

FIG. 5 is a flowchart illustrating a procedure for sensing a horizontal level of cathode in a cathode level sensing apparatus according to an exemplary disclosed embodiment. First, a wafer W is supplied into a process chamber through a slit door formed in a sidewall of the process chamber (S200). When the wafer is supplied into the process chamber, a gap motor(not shown) is driven and four ball screws 126 ascend through the ball ledges 124 causing the flange 122 to rise, as shown in FIGS. 2A and 2B. The gap bellows 120 is loosed by the rising of the flange 122, and so the cathode 1 16 rises (S202). That is, the cathode 116 rises higher by a distance from a ball screw fixation plate 130 that equals the difference between reference characters A and B.

When the cathode 116 rises like this, light is irradiated from a light emitting sensor of the sensor unit 132 to a lower face of the cathode 116 (S204). At this time, it may be beneficial to irradiate light C to three points of the cathode 116 by using first, second and third sensors 132a, 132b, and 132c respectively, disposed with the same interval on the ball screw fixation plate 130. In particular the light C irradiated from the light emitting sensor of the sensor unit 132 reaches a lower face of the cathode, and is then reflected. Moreover, a light receiving sensor of the sensor unit 132 receives light D reflected from the lower face of the cathode 116, and the light path measuring unit 134 measures a length of the reflected light D (S206).

Subsequently, the data of reflected light D measured through the light path measuring unit 134 is transmitted to the operating unit 136. The operating unit 136 decides whether the length of the transmitted reflected light is within a range of a predetermined reference data, that is, whether it is within a reference range of distance between the cathode 116 and the ball screw fixation plate 130 (S208).

If the operating unit 136 determines that the length of the reflected light D is not within the reference range, the controller 138 interlocks the equipment and then controls a horizontal level of the cathode 116 (S210). To this end, controlling the horizontal level of the cathode 116 may include a manual method and an automatic method. In the manual method, an engineer may loosen the ball screw 126 so that a gap between the cathode 116 and the ball screw fixation plate 130 falls within the desired range. Alternatively, the automatic method may use an automatic control system.

On the other hand, if the length of the reflected light D is within the reference range, a wafer is loaded on the rising cathode 116 by using equipment such as, for example, a robot arm (S212). When the wafer is safely mounted on the cathode 116, the flange 122 descends to shrink the gap bellows 120, thus causing the cathode 116 to descend. Then, a general plasma etching process is performed for the wafer (S214).

In detail, the cathode 116 on which the wafer was loaded descends, and then the slit door is closed, thus cutting off the process chamber from the outside environment which includes a transfer chamber. Subsequently, the interior of the process chamber is transformed into a high-vacuum atmosphere by using a vacuum device. When a slit door valve is opened to supply the wafer into the process chamber, air from the transfer chamber flows into the process chamber. This inflow of air into the process chamber increases the pressure of the process chamber to a level of about 1×10⁻³ torr. The increased pressure of the process chamber is reduced to achieve high vacuum that is required for the plasma etching process. Then, RF power is applied to each of the upper electrode and the cathode 116, thus generating plasma within the process chamber. In an exemplary embodiment, in order to generate plasma, a power of 350 watt may be applied to the upper electrode, and a power of 700 watt may be applied to its corresponding cathode 116. When a plasma atmosphere is formed within the process chamber through such procedures, a material layer formed on the wafer is etched in a desired pattern.

After a completion of the plasma etching process, the cathode ascends again (S216). Then the wafer is taken out of the process chamber through the slit door (S218).

As described above, according to an exemplary disclosed embodiment, a horizontal level state of a cathode that ascends and descends by a bellows is monitored in real time by using a level sensing apparatus that includes a sensor unit, a light path measuring unit, an operating unit and a controller. The use of such an apparatus may reduce problems experienced in conventional art devices. These problems may include, for example, scratching of an inner wall of a process chamber due to the cathode ascending and descending under an unbalanced state and so polluting the equipment and wafers due to dropped particles that adhere to the inner wall of the process chamber. Furthermore, the horizontal level state of cathode is monitored in real time and, therefore, any occurrence of an error in the horizontal level of the cathode, can be immediately determined and the level of the cathode may be accordingly adjusted. Therefore, the gap between the cathode and the upper electrode of the equipment may be kept constant ensuring a smooth unit process in the process chamber.

The disclosed apparatus and method may be applied to all semiconductor device manufacturing equipments having a susceptor on which wafers are loaded, including the plasma dry etching equipment. In addition, though the disclosure describes irradiating light on to a lower face of a lifted-up cathode, one skilled in the art will appreciate that a sensor unit may be formed on an upper part of the cathode to irradiate light on to an upper face of a lifted-up cathode, without departing from the scope of the disclosure.

It will be apparent to those skilled in the art that modifications and variations can be made in the present disclosure without deviating from the spirit or scope of the invention. Thus, it is intended that the present invention cover any such modifications and variations of this invention provided they come within the scope of the appended claims and their equivalents. Accordingly, these and other changes and modifications are seen to be within the true spirit and scope of the invention as defined by the appended claims.

What is claimed is:

1. An apparatus for sensing the position of a susceptor in semiconductor device manufacturing equipment, the apparatus comprising:
a susceptor which receives a wafer and high frequency power;
a sensor unit which irradiates light to a lower face of the susceptor when the susceptor is in a lifted up state and which receives light reflected from the lower face of the susceptor;
a light path measuring unit which measures a length of the light reflected to the sensor unit;
an operating unit which compares the length of the light measured by the light path measuring unit, with reference data indicating a rising height of the susceptor, and which decides whether the length of the measured light is within a range of the reference data; and
a controller which interlocks a process equipment when the length of the measured light deviates from the range of the reference data, and which controls a horizontal level state of the susceptor.

2. The apparatus of claim 1 wherein the susceptor is a cathode.

3. The apparatus of claim 1, wherein the sensor unit is a photosensor including a light emitting sensor and a light receiving sensor.

4. The apparatus of claim 1, wherein the sensor unit includes one or more sensors.

5. The apparatus of claim 1, wherein the sensor unit irradiates light to an upper face of the susceptor, and receives light reflected from the upper face of the susceptor.

6. An apparatus for sensing the position of a susceptor in semiconductor device manufacturing equipment, the apparatus comprising:
a susceptor which receives a wafer and high frequency power;
a bellows formed under the susceptor, which supports the susceptor,
a flange formed under the bellows, the flange having a plurality of ball screws piercing there through, and ascending and descending in a vertical straight movement of the ball screws, the ball screws having the vertical straight movement according to a drive of motor;
a ball screw fixation plate formed in an upper end portion of the ball screw driving the flange in a vertical direction, the ball screw fixation plate being configured to fix the ball screw;
a sensor unit formed on the ball screw fixation plate, which irradiates light to a lower face of the susceptor when the susceptor is in a lifted up state, and which receives light reflected from the lower face of the susceptor;
a light path measuring unit which measures a length of the light reflected to the sensor unit,
an operating unit which compares the length of the light measured by the light path measuring unit, with reference data indicating a rising height of the susceptor, and which decides whether the length of the measured light is within a range of the reference data; and
a controller which interlocks a process equipment when the length of the measured light deviates from the range of the reference data, and which controls a horizontal level state of the susceptor.

7. The apparatus of claim 6, wherein the susceptor is a cathode.

8. The apparatus of claim 6, wherein the sensor unit is a photo sensor including a light emitting sensor and a light receiving sensor.

9. The apparatus of claim 6, wherein the sensor unit includes one or more sensors.

10. The apparatus of claim 6, further comprising a chain unit which fixes the ball screws having the vertical straight movement.

11. The apparatus of claim 6, wherein the susceptor ascends and descends according to a shrinkage and relaxation of the bellows coupled to the flange performing an up and down straight movement based on a movement of the ball screw.

12. The apparatus of claim 6, wherein the sensor unit irradiates light to an upper face of the susceptor and receives light reflected from the upper face of the susceptor.

13. A method of sensing the position of a susceptor in semiconductor device manufacturing equipment, the method comprising:
supplying a wafer into a process chamber;
lifting up a susceptor on which the wafer supplied into the process chamber will be mounted;
irradiating light to a lower face of the lifted-up susceptor;
receiving light reflected from the lower face of the susceptor, and measuring a length of the reflected light;
determining whether the length of the reflected light is within a range of reference data indicating a rising height of the susceptor; and
interlocking a process equipment when the length of the reflected light deviates from the range of the reference data, and controlling a horizontal level state of the susceptor.

14. The method of claim 13, wherein the susceptor is a cathode.

15. The method of claim 13, wherein the susceptor ascends and descends according to a shrinkage and relaxation of a bellows coupled to a flange performing an up and down straight movement based on a movement of ball screws, the susceptor, the bellows, the flange, and the balls screw being operatively interconnected with each other.

16. The method of claim 13, wherein irradiating light to the lower face of the lifted-up susceptor includes emitting light from a photosensor to the susceptor.

17. The method of claim 13, wherein the light is irradiated on to one or more points of the lower face of the lifted-up susceptor.

18. The method of claim 13, wherein the wafer is supplied into and is taken out of the process chamber through a slit door.

19. The method of claim 13, further comprising irradiating light on to an upper face of the lifted-up susceptor, receiving light reflected from the upper face of the susceptor, and measuring a length of the reflected light.
